(19) United States
(12) Patent Application Publication
(10) Pub. No.: US 2022/0071841 A1
(43) Pub. Date: Mar. 10, 2022

(54) Cuirass Negative Pressure Ventilator with Reconfigurable Components and Internet of Things Capabilities

(71) Applicant: Stephen Medaris Bull, Greenport, NY (US)

(72) Inventor: Stephen Medaris Bull, Greenport, NY (US)

(21) Appl. No.: 17/467,200

(22) Filed: Sep. 4, 2021

Related U.S. Application Data
(63) Continuation of application No. 63/074,862, filed on Sep. 4, 2020.

(51) Int. Cl. A61H 31/02

(52) U.S. Cl. CPC A61H 31/02; A61H 2031/001; A61H 2201/5097

(57) ABSTRACT

The cuirass negative pressure ventilator is a light-weight self-contained iron lung to support the breathing of a patient in ambulatory or clinical settings. This cuirass-type ventilator comprises a shell member having a peripheral edge with a sealing device secured to said peripheral edge to provide a sealing region for sealing against a patient's body. An electric motor drives an atmospheric pressure changing pump attached to said cuirass to regulate the atmospheric pressure within said sealing region. A controller is attached to said cuirass to govern the timing of said pump motor. A power connector attached to said cuirass conveys power to said pump and said controller.

### PATENTS QUOTED

U.S. Pat. No. 6,345,618B1
EP0258302B1
U.S. Pat. No. 4,815,452A
U.S. Pat. No. 4,770,165A

### PRIOR ART

Negative pressure ventilator apparatuses include the “iron lung” type with the torso of the patient fully enclosed within the iron lung, for example as disclosed in U.S. Pat. Nos. 4,770,165 and 4,815,452. The cuirass negative pressure ventilator is generally a turtle shell-like enclosure applied to the front of the trunk of the patient connected to an air oscillator to provide breathing assistance. It is often preferable to use a negative pressure ventilator apparatus external to the body rather than intubating the patient for a positive pressure ventilator. Intubation is a procedure where the doctor puts a tube down the patient's throat and into their windpipe to make it easier to get air into and out of the lungs. Although cooperative patients can be intubated awake without any sedation at all, more commonly patients will require sedation. The maintenance of intubation for positive pressure ventilation requires constant monitoring by skilled clinical staff.

The present invention relates to ventilator apparatus, one example of which is the “cuirass ventilator,” also referred to as a negative pressure ventilator. Unlike the iron lung style of ventilator, the cuirass style ventilator described herein and in prior art attaches to the front side of the patient's torso.

The shell-like enclosure of the cuirass ventilator must be sufficiently sealed to the torso of the patient during the inhalation and expiration phases to prevent leakage due to patient movements. One solution is a custom-made shell tailored to the individual patient, as disclosed for babies in EP0258302B1. Custom tailoring is expensive and time-consuming to produce. Another technique is to provide a large number of different sizes of shell, each equipped for example with a foam-type sealing means about the periphery. These enclosure shells must be sufficiently rigid to allow for the correct breathing action, while at the same time having sufficiently flexible peripheral sealing to conform to the contours of the various individual patients wearing the apparatus.

A number of problems exist with prior solutions for the shell. For example, one solution disclosed in U.S. Pat. No. 6,345,618B1 requires a relatively large number of different sizes of shell be provided. The shell is typically applied to the patient by straps around the patient's back which may cause discomfort to the patient. The fixed overall design of the shell does not allow for the various collarbone shapes of the patient, nor allow for a comfortable fit around the patient's arm socket. The shell further requires attachment by hose to the separate pump motor and pump motor controller that constrains the patient's ambulatory movement and activities.

Based on patient and attendant medical staff reports as mentioned in U.S. Pat. No. 6,345,618B1, prior cuirass negative pressure ventilators may cause chafing or ulceration at certain points, for example, in the patient's collarbone area between the shoulders and the patient's arm pit region, and at the transition of the shell from across the chest to a portion of the shell down the patient's body and along the side of the chest. Frequent attention by the medical staff may be needed to attend to the patient to prevent chafing or ulceration by prior negative pressure ventilators.

It is difficult to seal the ventilator to the patient's chest in the various transition regions of the collarbone area, arm pits, sides of the patient's trunk and across the waist. The varying geometries of a patient's body associated with the different transition regions frequently leads to ineffective sealing of the apparatus, a problem encountered while developing the curved accordion-style seals disclosed in U.S. Pat. No. 4,815,452 and the simpler pleated seals taught in U.S. Pat. No. 6,345,618B1.

It would be desirable to provide an improved sealing device to give a greater degree of conformability to the contour of a patient. Such a sealing device would enable a smaller number of sizes of shells to be stocked and would substantially reduce patient discomfort. As the conformability of the ventilator could be provided by the sealing device, the choice of material for the shell is not as restrictive as with prior negative pressure ventilators.

It would be desirable to provide an improved strapping method to apply the shell to the patient. According to the present invention, a strapping device from the cuirass over the shoulders of the patient will increase the comfort of the patient and support the patient's ambulatory movement and activities.

A number of problems exist with prior solutions that have the oscillating pump motor attached remotely to the cuirass, as disclosed in U.S. Pat. Nos. 4,770,165 and 4,815,452. There is the problem of connecting and disconnecting the oscillating pump motor hose whenever the cuirass is in operation. There is the problem of the oscillating pump motor hose when attached to the cuirass interfering with patient mobility. There is the problem of the oscillating pump motor adding another device near the patient that can inhibit easy access to the patient by medical staff or home care staff whenever the cuirass is in operation. In the prior solutions, the required hose attachment from the oscillating pump motor to the cuirass constrains the patient's ambulatory movement and activities. An improved design would attach the oscillating pump motor directly to the cuirass if possible.

When designing a cuirass ventilator that allows more patient mobility, a number of additional problems exist with prior solutions such as taught in U.S. Pat. Nos. 4,770,165 and 4,815,452, wherein the oscillating pump motor controller attaches remotely to the ventilator. There is the issue of connecting and disconnecting the controller communication cables to the cuirass when it is in operation. There is the problem of the controller communication cables interfering with patient mobility when attached to the cuirass. There is the problem of the controller communication cables adding another device near the patient that can inhibit easy access to the patient by medical staff or home care staff whenever the cuirass is in operation. In the prior solutions the required attachment of the controller communication cables to the cuirass constrain the patient's mobility and activities. An improved design would attach controller communication cables within the enclosure of the cuirass of the negative pressure ventilator.

A number of problems exist with prior solutions that have the oscillating pump motor controller separated from the cuirass. For example, the medical staff, home care staff or patient are then required to prepare and supervise the operation of the negative pressure ventilator controller when in use on the patient. With the controller separated from the cuirass, the medical staff and home care staff are at some distance from the patient. The patient is unable to make changes to treatment or power the oscillating pump motor OFF because the controller interface is at a distance. In the prior solutions the separated controller constrains the patient's mobility and activities. An improved design would provide the oscillating pump motor controller with a location within the enclosure of the cuirass of the negative pressure ventilator.

It would be desirable to provide a cuirass with an improved shell member design that provides a greater degree of conformability to the contours of the transition region of the shoulders. Such a cuirass would enable a smaller number of standard sizes of shells to be stocked and would substantially reduce patient discomfort. As the conformability of the cuirass is provided by the redesign of the shell, the choice of material for the shell is not restrictive as in prior art devices.

According to the present invention, the cuirass's propensity for chafing will be at least reduced, or even eliminated.

It would also be desirable to provide a cuirass with a lower seal engagement pressure in the above-mentioned transition region while being capable of, in use, maintaining the required pressure conditions within the ventilator. Engagement pressure in the transition region of the patient would be reduced with the redesign, thereby reducing discomfort while at the same time maintaining the ventilator air pressure.

According to the present invention, it would be desirable to provide an improved sealing device which provides a greater degree of conformability to the contours of a patient. Such a sealing device would enable a smaller number of standard sizes of shells to be stocked and would substantially reduce patient discomfort.

### Description

According to the present invention, there is provided a cuirass ventilator comprising a shell member having a peripheral edge and a sealing device secured to the peripheral edge, the sealing device comprising a sealing member depending from the peripheral edge of the shell, the sealing member having a sealing region for sealing against a patient's body, a body portion having a securing region whereat the sealing member is secured to the shell and a resilient neoprene-like sealing member whereby, in use, the resilience of the neoprene-like member urges the sealing region into sealing engagement with a patient's body.

Preferably, the neoprene-like member comprises a plurality of neoprene-like layers connected serially being contiguous with said body portion at a transition region, and contiguous along the peripheral edge of the sealing region.

Conveniently the peripheral edge of the shell has a first portion which, in use, is disposed in proximity with the top of a patient's chest, second and third portions which extend substantially parallel to the patient's height and a fourth portion which extends across the abdomen of the patient and the sealing member is so secured to the shell member as to be inwardly directed in the second and third portions and to be downwardly directed towards the chest or respectively abdomen in the first and fourth portions.

Preferably respective transition portions extend contiguously between the first and second, and first and third portions, the transition portions, in use, being disposed in the armpit region of the patient.

Preferably in said transition portions, the sealing member is shaped for resilient conformability with the body of a patient.

Conveniently, said plurality of neoprene-like layers comprises at least two portions.

Advantageously, said plurality of neoprene-like layers comprises four portions.

Advantageously, the shell is provided with a peripheral flange region and the securing region of the sealing device has a counterpart surface for adhering therein the flange region. It is contemplated that an adhesive-like material will be used to attach the neoprene-like layer to the peripheral flange region. Some adhesive-like material could be double-stick tape or Velcro.

Advantageously, the flange region includes a securing lip for retaining the sealing device thereof.

It would also be desirable to provide a cuirass in which the atmospheric pressure changing pump motor is attached to the cuirass.

According to the present invention, the motor is mounted as a modular component to fit various sizes of the cuirass shell.

According to the present invention, the mobility of the patient increases and the patient is provided with audible feedback that the ventilator is working.

According to the present invention, the motor provides an audible cue for his inhalation.

According to the present invention, staff has easier access to the patient without having to manipulate a separate vacuum hose as in prior art.

It would also be desirable to provide a cuirass in which the controller is attached to the cuirass to govern the timing of the pump motor.

According to the present invention, the medical or home care staff are better able to get close to the patient to initiate therapy, to monitor the seal and pressure of the cuirass during operation, assess the comfort of the patient, and easily power the motor OFF.

According to the present invention, the patient has the ability to initiate his therapy, monitor the operation of the device, and turn off the cuirass apparatus.

It would also be desirable that the controller have an analog motor controller or a digital motor controller with microcontroller or a digital motor controller with Internet-of-Things capabilities.

According to the present invention, the motor controller is mounted as a modular component to fit various sizes of the cuirass shell.

According to the present invention, when the cuirass has an analog controller, the cuirass is less complicated and less expensive than prior art, providing the necessary quality of care with fewer options.

According to the present invention, the digital motor controller provides the medical and home care staff with a more complete understanding of the therapy given to the patient, and the operation of the device.

According to the present invention, the digital motor controller with micro-controller allows multiple sensors to be placed on the patient. The micro-controller receives signals from the patient's sensors about the patient's urge to inhale. exhale, cough and spit.

Preferably, the microcontroller governs the patient's tidal breathing, starting with the patient's urges to inhale.

According to the present invention, the digital motor controller with micro-controller receives signals from atmospheric sensors on the interior and exterior of the cuirass shell when the microcontroller is in operation. This permits the patient or the staff to make adjustments to the vacuum pressure within the cuirass device based on the data received.

It would also be desirable that the digital motor controller have Internet-of-Things report capabilities.

According to the present invention, the Internet-of-Things allows the staff to remotely monitor the patient's therapy and introduce a communication protocol.

Preferably, the communication protocol allows the staff to communicate directly to the cuirass device or to the patient wireless tablet or mobile phone,

Preferably, the communication protocol permits the patient's therapy from being written directly into the patient's electronic medical record.

Preferably, the communication protocol permits automatic billing by the patient's care provider with a record to the patient's insurers.

Preferably, the communication protocol, when combined with artificial intelligence a/k/a machine learning, analyzes the history of the patient's care, comparing the current status received with the earlier reports.

Preferably, the artificial intelligence compares the patient's therapy against the most current therapy protocol and similar cases to offer treatment suggestions to the patient's care provider.

Preferably, the artificial intelligence provides the patient's mobile device with suggestions for self-care, including links of interest, based on the data received.

It would also be desirable to have a low voltage universal safe DC power supply that plugs into the cuirass.

According to the present invention, an AC source to DC power supply allows continuous operation of the cuirass.

According to the present invention, the DC power supply could be provided by an automobile-like battery to operate the cuirass if there is a power outage.

According to the present invention, the DC power supply could be provided by a battery belt worn by the patient or in a backpack worn by the patient, providing mobility to the patient while the cuirass is in operation.

### DRAWINGS

An embodiment of the invention will now be described with respect to the accompanying drawings in which:

FIG. 1 shows a side view of an advantageous embodiment of the apparatus fitted on the torso of a patient. 1 is the cuirass negative pressure ventilator. 2 is the shell. 3 is the seal. 4 is the visible edge of a motor exhaust.

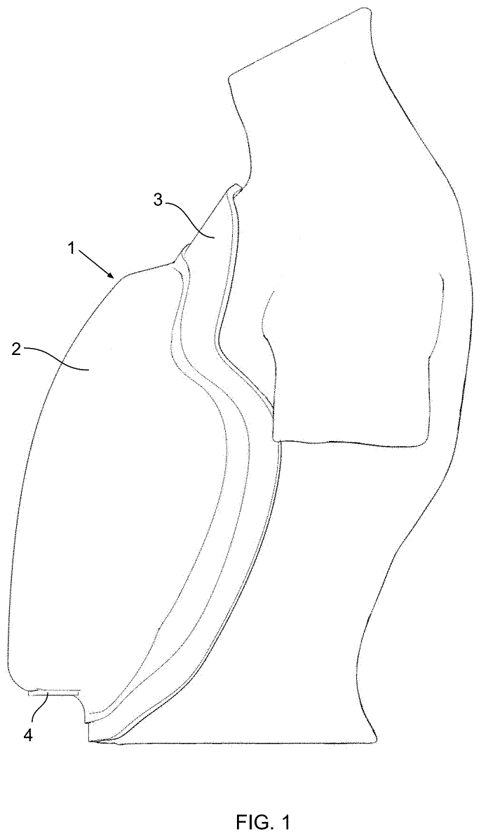

FIG. 2 shows a front view of an advantageous embodiment of the apparatus fitted on the torso of a patient. 1 is the cuirass negative pressure ventilator. 2 is the shell. 3 is the seal. 4 and 5 are visible edges of two motor exhausts in this embodiment. A smaller pediatric patient cuirass negative pressure ventilator might only require a single motor. In other embodiments such as for an obese patient the motors could be mounted on the exterior of said shell 2. Location 6 indicates a possible position for the user interface panel 6 of the motor controller.

FIG. 3 shows a bottom view of an advantageous embodiment of the apparatus. 1 is the cuirass negative pressure ventilator. 2 is the shell. 3 is the seal. 4 and 5 are the visible edges of two motor exhausts that is preferable in this embodiment.

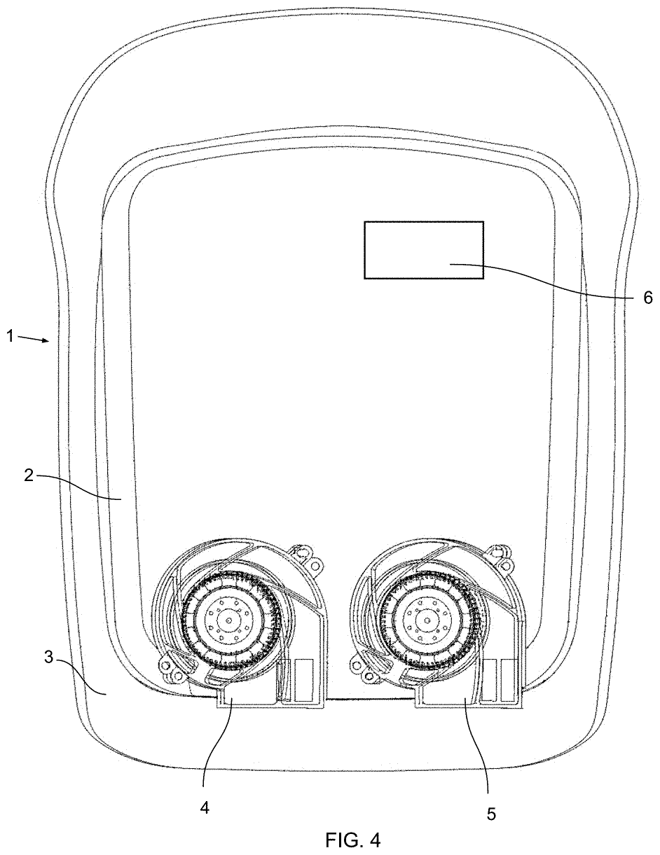

FIG. 4 shows a back view of an advantageous embodiment of the apparatus. 1 is the cuirass negative pressure ventilator. 2 is the shell. 3 is the seal. 4 and 5 show two motors preferable in this embodiment. 6 indicates a possible location of the motor controller against the inside of shell 2.

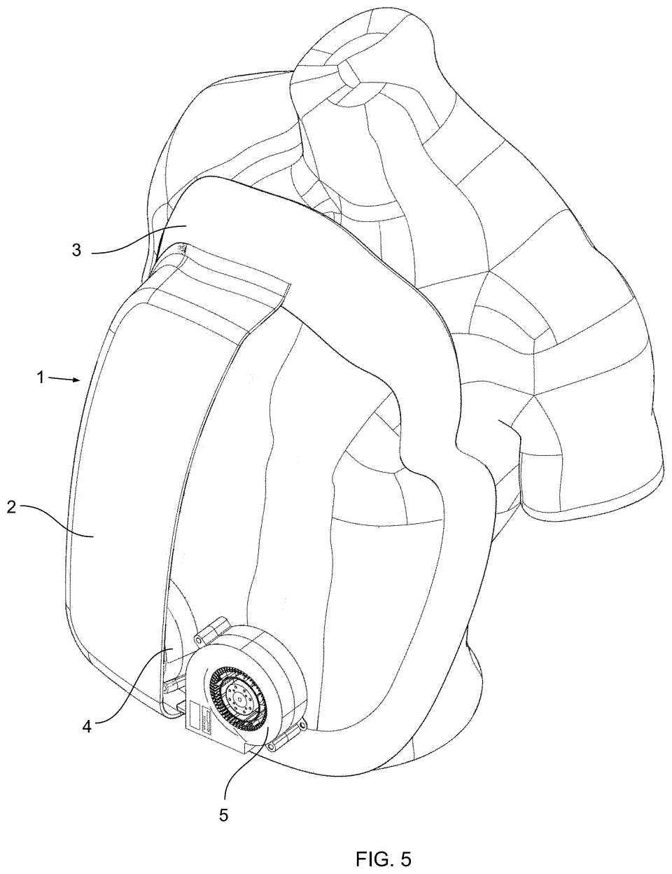

FIG. 5 shows an isometric front and side cut away view of an advantageous embodiment of the apparatus. 1 is the cuirass negative pressure ventilator. 2 is the shell. 3 is the seal. 4 and 5 show two motors preferable in this embodiment.

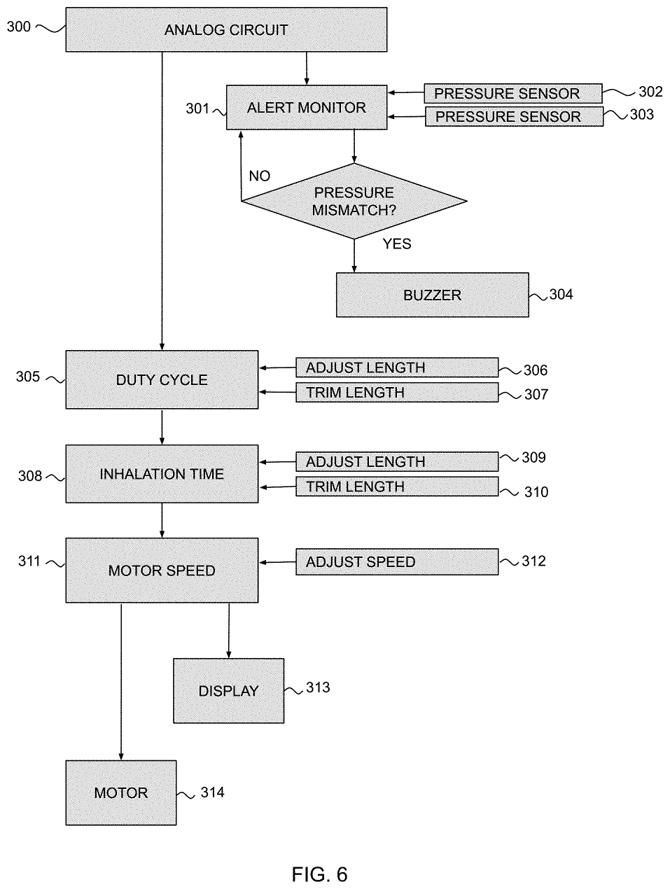

FIG. 6 shows an advantageous embodiment of the analog circuit and controller of the apparatus. An analog controller is used, rather than a digital controller, as it is expected to be the least expensive method to deliver the apparatus as an affordable medical device to a world-wide population. The initial chart step 300 represents the platform for a cluster of all the analog circuits of the controller.

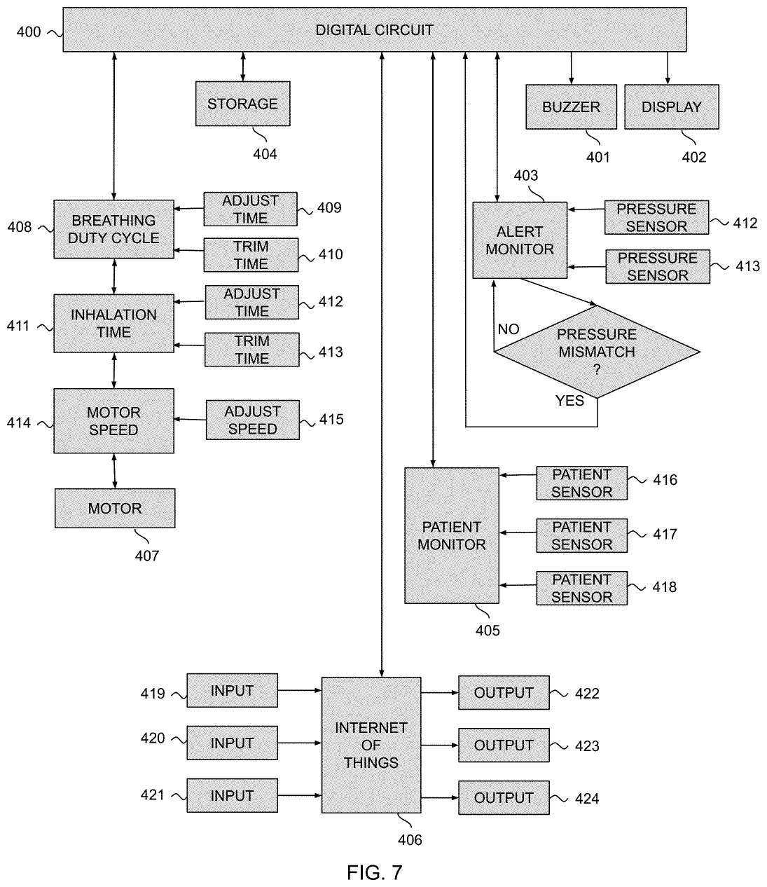

Alert monitoring of the apparatus occurs at the circuit step 301 wherein the atmospheric pressure measured via sensor 302 positioned on the exterior of the cuirass is continuously compared with measurements of the air pressure inside the cuirass via sensor 303 positioned on the interior of the cuirass. When the vacuum pressure difference between sensors 302 and 303 is insufficient to meet the vacuum specifications required within the containment volume of the cuirass, buzzer 304 produces an audible warning noise. The fit of the cuirass to the patient is then adjusted manually until an adequate level of vacuum suction is created and buzzer 304 turns off.

Circuit step 305 orchestrates the complete breathing duty cycle of the apparatus by setting the length of time for inhalation and exhalation provided by the device therapy. Step 306 allows a user to control the breathing frequency and step 307 adds a hidden ability for a technician to modify the range of user control 306.

Circuit step 308 gives a user control of the duration of the inhalation, with input 309 providing a user control of the inhalation duration and input 310 adding a hidden ability for a technician to modify the range of user control 308.

Step 311 is the circuit that gives a user control of the motor speed governing the amount of vacuum suction achieved within the apparatus. Input 312 allows a user to control the speed of the motor 314. Display 313 shows a visual display of the user adjustments.

FIG. 7 shows an advantageous embodiment of the digital circuit and controller of the apparatus. A digital controller is expected to provide greater user control by patient and care provider to the apparatus. With added Internet of Things capability remote patient monitoring is provided enabling communications between patient, care providers, equipment makers and other medical stakeholders. The initial chart step 400 represents the platform for a cluster of all the digital circuits of the controller.

Audio alerts and device status events of 400 are connected to a buzzer 401. Visual alerts and device status events of 400 are connected to a display 402. Alert notifications, device status events, and patient sensor readings of 400 are recorded on a data storage 404.

Alert monitoring of the apparatus occurs at the circuit step 403 wherein the atmospheric pressure measured via sensor 412 positioned on the exterior of the cuirass is continuously compared with measurements of the air pressure inside the cuirass via sensor 413 positioned on the interior of the cuirass. When the vacuum pressure difference between sensors 412 and 413 is insufficient to meet the vacuum specifications required within the containment volume of the cuirass, buzzer 401 produces an audible warning noise and display 402 shows a visual warning. The fit of the cuirass to the patient is then adjusted manually until an adequate level of vacuum suction is created and buzzer 401 turns off and display 402 shows normal operation. Data storage 404 records alerts.

Circuit step 408 orchestrates the complete breathing duty cycle of the apparatus by setting the length of time for inhalation and exhalation provided by the device therapy. Step 409 allows a user to control the breathing frequency and step 410 adds a hidden ability for a technician to modify the range of user control 409. Buzzer 401 delivers audio notifications as needed. Display 402 shows a visual display of the user adjustments. Data storage 404 records user adjustments.

Circuit step 411 gives a user control of the duration of the inhalation, with input 412 providing a user control of the inhalation duration and input 413 adding a hidden ability for a technician to modify the range of user control 412. Buzzer 401 delivers audio notifications. Display 402 shows a visual display of the user adjustments. Data storage 404 records user adjustments.

Circuit step 414 is the circuit that gives a user control of the motor speed governing the amount of vacuum suction achieved within the apparatus. Input 415 allows a user to control the speed of the motor 407. Buzzer 401 delivers audio notifications. Display 402 shows a visual display of the user adjustments. Data storage 404 records user adjustments.

Circuit step 405 is the patient monitor circuit that gathers from various industry standard 3rd party patient sensors and future sensors to be put into use. Patient sensors 416, 417, and 418 are examples of sensor input points to 405 that has capability to add more patient sensors. Data storage 404 records patient sensor data.

Circuit step 406 is the Internet of Things circuit that makes the apparatus an object on a system of interrelated, internet-connected objects and gives the apparatus the ability to collect and transfer data over a wireless network without human intervention. Inputs 419, 420, and 421 are examples of exterior wireless network communications to 406. Outputs 422, 423, and 424 are examples of data transfers broadcasts from 406. Data storage 404 records 406 activity.

### DETAILED DESCRIPTION

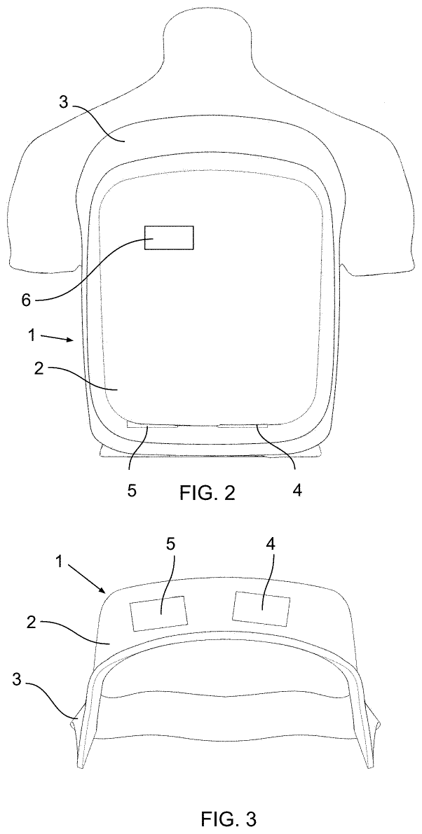

According to a first aspect of the present invention there is an improved cuirass design that provides a greater degree of conformability to the contours of the transition region in the area of the shoulders. In the drawing of the plan view of the shell of the cuirass, the FIG. 2 shows the top of the cuirass shell below the patient's collarbone and the cutouts of the upper left and upper right shell allowing for generous movement of the arms in their shoulder sockets. The bottom of the cuirass shell finishes just below the patient's diaphragm.

According to a second aspect of the present invention there is provided an improved ventilator sealing device comprising a body portion for securing the sealing device to a peripheral edge of a cuirass ventilator, a sealing region for sealing against a patient's body, and a neoprene-like layers intermediate the body portion and the sealing region.

Preferably the sealing device forms a ring. Advantageously the neoprene-like layers comprise a plurality of seal portions connected serially whereat the sealing member is secured to the shell and a resilient neoprene-like sealing member whereby, in use, the resilience of the neoprene-like member urges the sealing region into sealing engagement with a patient's body in four portions. A first end portion of said neoprene-like layers being contiguous with said body portion at the first neoprene-like layers, and a second end portion, neoprene-like layers opposite said first end portion being contiguous with said sealing region at the second neoprene-like layer.

According to a third aspect of the present invention, an atmospheric pressure changing pump motor is attached to the cuirass.

According to a fourth aspect of the present invention, a motor controller is attached to the cuirass.

According to a fifth aspect of the present invention, attached power supply methods enable the operation of the cuirass.

What is claimed is:

1. A cuirass ventilator having a shell member, a seal, a vacuum motor, a motor controller and power connector means, said shell member having a front portion and a rear portion, each of said front and rear portions having a top edge and two side edges, said shell member further having two opposing side portions, each of said side portions having a respective edge, said edges of said front, rear and side portions together forming a peripheral edge running continuously around said shell member, and said seal depending from said peripheral edge and running around said peripheral edge wherein said seal has a resilient sealing region, wherein said resilient sealing region urges said sealing region into sealing engagement when disposed on a patient's body, where said vacuum motor lowers or increases the atmospheric pressure within said cuirass ventilator when disposed on a patient's body, and said motor controller permitting the patient or care provider to regulate the operation of said vacuum motor by user interface to said motor controller, said motor controller further storing input and output data of the patient therapy status and operational status of said cuirass ventilator, said motor controller further having wireless communication means for transmitting data protocols to and from remote locations, and a power connecter means to enable the cuirass ventilator to be a complete functional standalone device.

2. The cuirass ventilator of claim 1, wherein said shell member is fabricated with accommodation for various body shapes and sizes and accommodation of a top edge shaping enhancement to prevent chafing around the patient's collarbone area and accommodation of a top to side corner edge shaping enhancement to prevent chafing of the patient's armpit contact area.

3. The cuirass ventilator of claim 2, wherein the seal is so secured to said shell member as to be inwardly directed with respect to said opposing side portions and to be downwardly directed with respect to said top edges of said front and rear edge portions.

4. The cuirass ventilator of claim 3, wherein said shell further comprises respective transition portions which extend contiguously between each side edge of said front portion and edge of said respective side portion.

5. The cuirass ventilator of claim 4, wherein said transition portions, said seal is shaped for resilient conformability to the body of a patient when so disposed.

6. The cuirass ventilator of claim 1, wherein said shell member is provided with a peripheral flange region and said securing region of said seal comprises a shared surface for said adhesive attachment of seal to shell member or provided releasable fastener for securing said seal to said shell.

7. The cuirass ventilator of claim 1, wherein said vacuum motor or vacuum motors lower or increase the atmospheric pressure within the cuirass ventilator when disposed on a patient's body.

8. The cuirass ventilator of claim 1, wherein said vacuum motor or vacuum motors are connected by modular method to said shell.

9. The cuirass ventilator of claim 1, wherein said motor controller regulates the operation of said vacuum motor by patient or care provider by user interface to said motor controller whereby a patient or care provider can regulate the operation of the vacuum motor.

10. The cuirass ventilator of claim 1, wherein said motor controller is connected by modular method to said shell.

11. The cuirass ventilator of claim 9, wherein said motor controller has the capacity to collect and store data from said patient sensors.

12. The cuirass ventilator of claim 9, wherein said motor controller has the capacity to process said stored patient data to change the operation of said vacuum motor.

13. The cuirass ventilator of claim 9, wherein said motor controller has the capacity to collect the history of operation of said vacuum motor and the environmental data of the patient's surroundings.

14. The cuirass ventilator of claim 9, wherein said motor controller has the wireless communication ability to connect with remote communication infrastructure.

15. The cuirass ventilator of claim 9, wherein said wireless communication transmits stored and ongoing operation to remote communication infrastructure.

16. The cuirass ventilator of claim 9, wherein said wireless communication receives operation commands from remote communication infrastructure.

17. The cuirass ventilator of claim 13, wherein said wireless communication transmissions enable an automatic updating of a patient's electronic medical record.

18. The cuirass ventilator of claim 19, wherein said wireless communication transmissions enable an automatic notification of a patient's care provider of a change of patient's self-treatment.

19. The cuirass ventilator of claim 1, wherein said power connecter means provides the method of electrical power to the apparatus from multiple commonly available power sources.

20. The cuirass ventilator apparatus of claim 1, wherein said power connecter means carries electric power to said apparatus giving patient mobility.
